(19) United States
(12) Patent Application Publication
(10) Pub. No.: US 2018/0077136 A1
(43) Pub. Date: Mar. 15, 2018

(54) COMMON STORAGE MODE IN CAMERA

(71) Applicant: QUALCOMM Incorporated, San Diego, CA (US)

(72) Inventors: Nagaraju GAJULA, Hyderabad (IN); Sumanth Kumar KOTA, Hyderabad (IN); Sasikanth Reddy ADAPALA, Hyderabad (IN)

(21) Appl. No.: 15/261,364

(22) Filed: Sep. 9, 2016

(51) Int. Cl. H04L 29/06; G06K 19/06; H04N 1/21; G06K 9/00

(52) U.S. Cl. CPC H04L 63/083; G06K 19/06037; G06K 9/00228; H04N 1/2166; G06K 19/06028

(57) ABSTRACT

In an aspect of the disclosure, a method, a computer-readable medium, and an apparatus for multimedia storage and organization are provided. The apparatus may be a camera. The apparatus may receive a code for a common storage mode. The code may be associated with an event. The apparatus may enter the common storage mode based on the code. The apparatus may upload photos or videos taken under the common storage mode to a common storage location based on the code. The common storage location may be shared by a plurality of cameras. The code may allow access to the common storage location.

### BACKGROUND

### Field

The present disclosure relates generally to multimedia storage and organization, and more particularly, to an event-based common storage mode in camera.

### Background

A person may attend many parties during his or her college days like a fresher's party, a farewell party, or other college parties/festivities. But the person may not be able to capture photos or videos at some of such parties, as she may not have carried a camera, or her camera may be unavailable at the party (e.g., her camera may run out of battery or memory space at the party). In order to retrieve photos or videos taken at the party, she might need to contact one of her friends who may have taken photos or videos at the party and stored the photos or videos at the friend's personal storage space (e.g., flash drive, hard disk), which may be secured by a password. Sometimes, the friend may have deleted the photos or videos, thus the memories of the party may be lost. The scenario described above may happen to anyone. Everyone in his or her life may lose photos or videos (memories) of some of the parties or events he or she attended.

People attending a party or event may bring cameras to the party or event. Different cameras may capture different styles of photos, different photos, different scenes, etc. After the party or event, the pictures or videos captured by the different cameras may not be available at a single place or location. Each participant of the party or event may desire photos or videos taken by other cameras, which may have a higher quality (e.g., higher resolution, better contrast, better depth of field, or better perspective, etc.).

Since the photos or videos of an event may be shared across all the participants of the event, each individual or family may store the photos or videos on the individual's or family's computers, resulting in increasing computer storage of shared photos around the globe.

### SUMMARY

The following presents a simplified summary of one or more aspects in order to provide a basic understanding of such aspects. The summary is not an extensive overview of all contemplated aspects, and is intended to neither identify key or critical elements of all aspects nor delineate the scope of any or all aspects. The summary's sole purpose is to present some concepts of one or more aspects in a simplified form as a prelude to the more detailed description that is presented later.

A person may lose photos or videos of a party or event attended by that person. For example, the person may lose photos or vides taken by other participants at the party or event, or may desire to have access to such photos or videos. Each participant of the party or event may store the same photos or videos on his or her computer, resulting in growing duplicity in computer storage.

In an aspect of the disclosure, a method, a computer-readable medium, and an apparatus for multimedia storage and organization are provided. The apparatus may be a camera. The apparatus may receive a code for a common storage mode. The code may be associated with an event. The apparatus may enter the common storage mode based on the code. The apparatus may upload photos or videos taken under the common storage mode to a common storage location based on the code. The common storage location may be shared by a plurality of cameras. The code may allow access to the common storage location.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of using a common storage mode in cameras to store and organize photos and videos captured by the cameras.

FIG. 2 is a flowchart of a method of multimedia storage and organization.

FIG. 3 is a conceptual data flow diagram illustrating the data flow between different means/components in an exemplary apparatus.

FIG. 4 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of multimedia storage and organization will now be presented with reference to various apparatus and methods. These apparatus and methods will be described in the following detailed description and illustrated in the accompanying drawings by various blocks, components, circuits, processes, algorithms, etc. (collectively referred to as “elements”). The elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

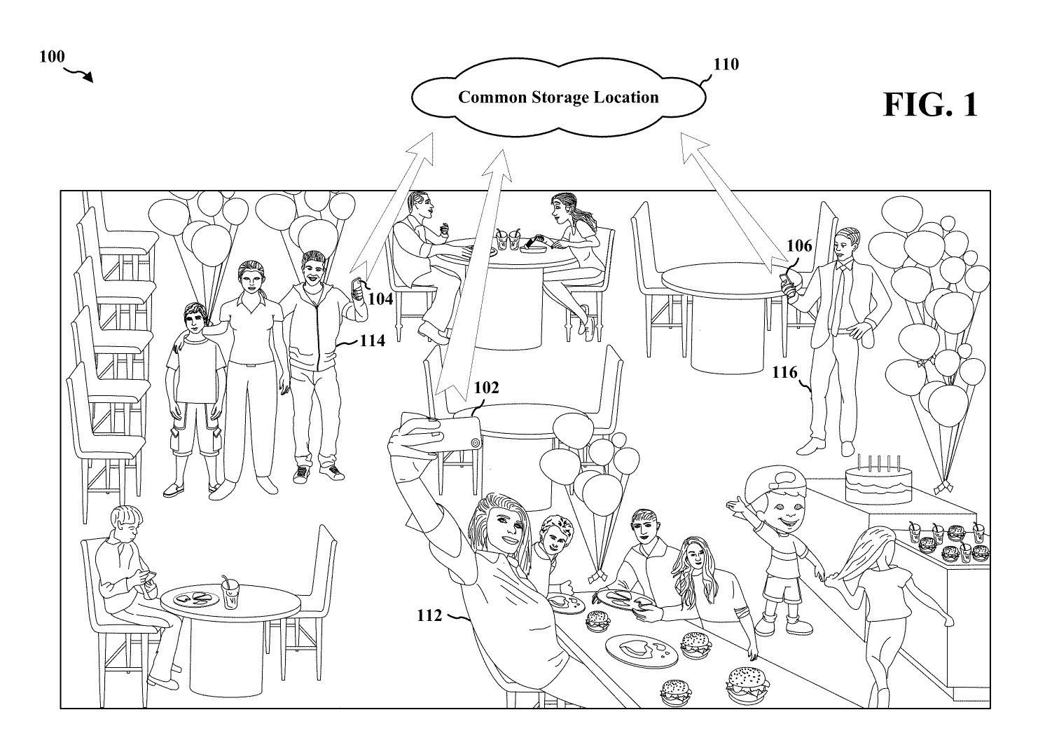

FIG. 1 is a diagram 100 illustrating an example of using a common storage mode in cameras to store and organize photos and videos captured by the cameras. In this example, more than a dozen people are attending a birthday party. Three attendees 112, 114, and 116 of the birthday party may use cameras 102, 104, and 106, respectively, to take pictures and/or videos of the party scene. Each of the cameras 102, 104, and 106 may be an optical instrument for recording or capturing images, which may be stored locally, transmitted to another location, or both. The images may be individual still photographs or sequences of images constituting videos or movies.

In an aspect, a new mode of camera operation referred to herein as ‘common storage mode’ may be introduced for the cameras 102, 104, and 106. A unique code may be generated for authenticating the common storage mode in a camera for a particular event/party. For example, the host or organizer of the party or event may generate a unique code for the party/event. In one configuration, the host/organizer may send the unique code to all the attendees (e.g., as part of the invitation). In one configuration, the host/organizer may broadcast the unique code to everyone (e.g., general public, or all cameras within a geographic area, etc.) The unique code may be associated with the event/party. In one configuration, a different party/event may have a different code for authenticating the common storage mode in a camera. In such a configuration, the camera may switch between the different codes when taking pictures/videos at the different events/parties. In one configuration, a person may attend different sessions at an event, each session having a different code such that the person may take photos at each session and store the photos of each session in respective common storage locations.

In one configuration, the unique code may be a Quick Response (QR) code or other type of barcode. In one configuration, the unique code may include one or more of: the effective time period for accessing the common storage mode, the duration of the event, the maximum resolution of a photo or a video to be uploaded, the access permission of the common storage location, the maximum number of photos or videos that can be uploaded by each camera, or the maximum size of photos or videos that can be uploaded by each camera. For example, the unique code may specify the effective time period for accessing the common storage mode to be two months from the date of generating the unique code. The unique code may specify that the duration of the event to be from 9:00 AM to 2:00 PM of a particular day. Thus photos and/or videos taken under common storage mode with the unique code during that time period may be uploaded to the common storage location associated with the unique code. The unique code may specify that the attendees of the party/event may have read and/or write permission for the common storage location associated with the unique code.

If the attendees 112, 114, and 116 want photos and/or videos taken by the cameras 102, 104, and 106 to be shared, the attendees 112, 114, and 116 may enable common storage mode in the cameras 102, 104, and 106, respectively, with the code provided. In one configuration, the attendees 112, 114, and 116 may turn on or off the common storage mode before taking a photo or video. Photos and/or videos taken by all the cameras (e.g., the cameras 102, 104, and 106) under the common storage mode may be stored or uploaded to a common storage location (e.g., a common storage location 110). Photos and/or videos that are not taken under the common storage mode (e.g., when the common storage mode is turned off) may not be stored or uploaded to the common storage location.

In one configuration, the camera owner may decide which photos/videos to be uploaded to the common storage location 110. The camera owner may be provided with options to upload only group photos and avoid selfies, upload selfies which have more than one person in it, upload only if the image has more than one of the registered users of the event, upload only if it can detect a face in the image, etc.

In one configuration, the common storage location 110 may be a cloud storage location. In one configuration, the uploading of the photos and/or videos taken under the common storage mode to the common storage location may occur automatically as the photos/videos are taken. Alternatively, the photos or videos may be uploaded in the background (e.g., when the camera is not taking photos/videos) so as to not interfere with taking photos/videos, or may be uploaded when a free wireless connection (e.g., a Wi-Fi connection) is available to save data usage against a subscribed wireless plan. In one configuration, the common storage location 110 associated with a particular code may be a container (e.g., a file folder) that groups all the pictures/videos taken under the common storage mode at the event associated with the code. Thus, the pictures/videos taken under common storage mode may be grouped based on event/party.

In one configuration, photos/videos taken during the event may be uploaded automatically and made available to authorized people (e.g., people having the code) instantaneously. Other attendees of the event can access the uploaded photos/videos instantaneously instead of waiting for the persons who captured the photos/videos to share separately.

Attendees having the code associated with a party/event may access photos and/or videos taken by all cameras (e.g., the cameras 102, 104, and 106) with the common storage mode enabled with the code for the party or event. In one configuration, the photos and/or videos may be stored in the common storage location 110 with photos from each camera stored in respective folders. For example, photos and/or videos taken by the camera 102 may be stored in a folder for camera 102 on the common storage location 110, photos and/or videos taken by the camera 104 may be stored in a folder for camera 104 on the common storage location 110, and photos and/or videos taken by the camera 106 may be stored in a folder for camera 106 on the common storage location 110. In one configuration, the photos and/or videos may be stored in the common storage location 110 based on facial recognition. For example, photos and/or videos in which the attendee 112 is in may be stored in a folder for attendee 112, photos and/or videos in which the attendee 114 is in may be stored in a folder for attendee 114, and photos and/or videos in which the attendee 116 is in may be stored in a folder for attendee 116.

Examples of cameras 102, 104, 106 may include a cellular phone, a smart phone, a laptop, a personal digital assistant (PDA), a game console, a tablet, a smart device, a wearable device, or any other similar functioning device. Each of the cameras 102, 104, 106 may also be referred to as a user equipment (UE), a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

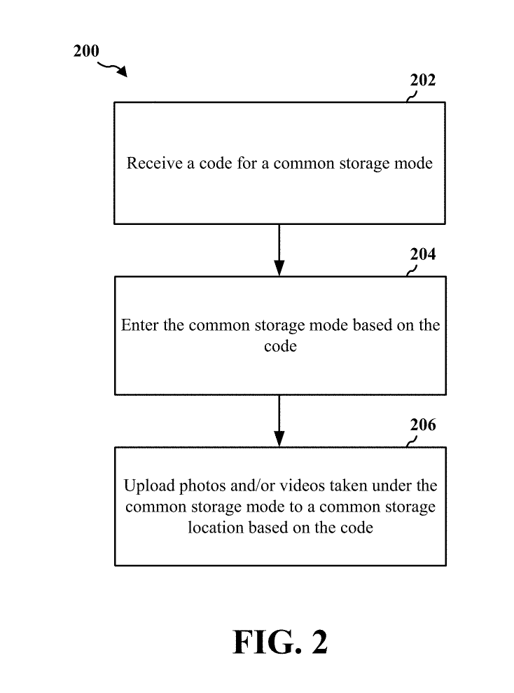

FIG. 2 is a flowchart 200 of a method of multimedia storage and organization. The method may be performed by a camera (e.g., the camera 102, 104, 106, the apparatus 302/302′). At 202, the camera may receive a code for a common storage mode. In one configuration, the camera may have access to a calendar and the code may be automatically retrieved from the calendar. In one configuration, the code may be associated with an event (e.g., a party). In one configuration, the code may be generated by an organizer of the event and made available to attendees along with event invitations. In one configuration, the code may be a QR code.

At 204, the camera may enter the common storage mode based on the code. In one configuration, the code may be a first code associated with a first event. In such a configuration, the camera may receive a second code associated with a second event, and switch from the first code to the second code when switching from the first event to the second event. For example, the first code and the second code may be loaded into the camera. The first code may be selected when taking photos/videos at the first event, and the second code may be selected when taking photos/videos at the second event.

At 206, the camera may upload photos and/or videos taken under the common storage mode to a common storage location based on the code. In one configuration, the uploading of the photos and/or videos taken under the common storage mode to the common storage location may occur automatically as the photos/videos are taken. Alternatively, the photos or videos may be uploaded in the background (e.g., when the camera is not taking photos/videos) so as to not interfere with taking photos/videos, or may be uploaded when a free wireless connection (e.g., a Wi-Fi connection) is available to save data usage against a subscribed wireless plan.

In one configuration, the code may be shared by a plurality of cameras. In such a configuration, the common storage location may be shared by the plurality of cameras. The code may allow access to the common storage location. In one configuration, the common storage location may include a plurality of folders, each folder for a particular one of the plurality of cameras. In one configuration, files stored at the common storage location may be organized based on facial recognition. For example, if a first person is recognized in a photo/video through facial recognition, the photo/video may be stored in a first file folder for the first person. If a second person is also recognized in the photo/video through facial recognition, the photo/video may also be stored in a second file folder for the second person. Therefore, all photos/videos in which the first person is recognized may be stored in the first file folder for the first person, and all photos/videos in which the second person is recognized may be stored in the second file folder for the second person.

In one configuration, facial recognition may be performed at a cloud server where the images (e.g., photos and/or videos) are stored. In one configuration, when images are uploaded to the cloud server, the cloud server may run the facial recognition and other techniques to sort out the images based on faces/locations, etc.

In one configuration, the code may include one or more of: an effective time period for accessing the common storage mode, the duration of an event, a maximum resolution of a photo or a video to be uploaded, an access permission of the common storage location, a maximum number of photos or videos that can be uploaded by the camera, or a maximum size of photos or videos that can be uploaded by the camera. For example, the camera may validate the current time is within the duration of the event specified by the code before entering the common storage mode based on the code. In another example, the camera may check the resolution of a photo/video before the photo/video is uploaded. If the resolution of the photo/video is higher than the maximum resolution specified by the code, the resolution of the photo/video may be reduced prior to the photo/video being uploaded. In yet another example, if the number of photo/videos taken by the camera under the common storage mode for an event exceeds the maximum number of photos/videos that can be uploaded specified by the code, the camera may randomly select the maximum number of photos/videos to upload.

In one configuration, the camera may provide a set of filtering options for the photos or videos taken under the common storage mode. The set of filtering options may include, e.g., uploading only group photos and avoid selfies, uploading selfies which have more than one person in it, uploading only if the image has more than one of the registered users of the event, uploading only if it can detect a face in the image, etc. The camera may receive a selection of the set of filtering options. The camera may filter the photos or videos taken under the common storage mode based on the selection of the filtering options, and upload the filtered photos/videos.

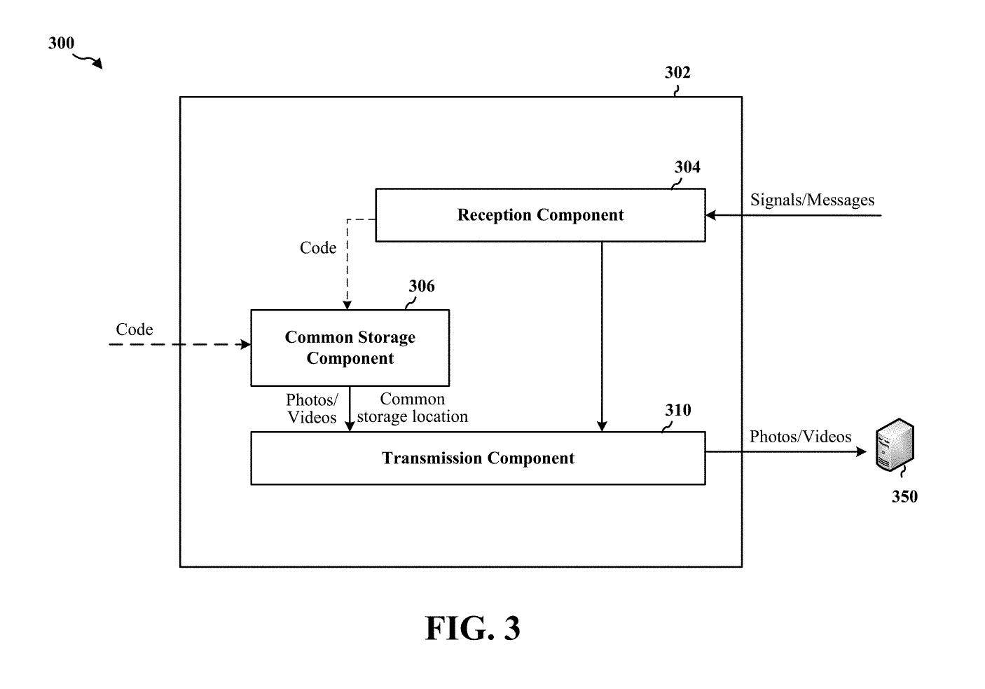

FIG. 3 is a conceptual data flow diagram 300 illustrating the data flow between different means/components in an exemplary apparatus 302. The apparatus may be a camera. The apparatus 302 may include a reception component 304 that receives signals/messages from other devices, which may be a UE, a base station, a sever, or any suitable device. The signals/messages may be received through any radio access technology (RAT), such as Bluetooth, Wi-Fi, and 3G, 4G, or LTE. In one configuration, the signals received may include information for a code for common storage mode. The apparatus 302 may include a transmission component 310 that uploads photos and/or videos to a server 350. The server 350 may provide a cloud storage service. In one configuration, the transmission component 310 may perform operations described above with reference to 206 in FIG. 2. The reception component 304 and the transmission component 310 may cooperate to coordinate the communication of the apparatus 302.

The apparatus 302 may include a common storage component 306 that receives a code, enters common storage mode based on the code, and sends a common storage location and photos/videos taken under the common storage mode to the transmission component 310, which uploads the photos/videos to the common storage location. In one configuration, the code may be received through user input or scanning a bar code (e.g., QR code). In one configuration, the bar code may be provided at the event and scanned by the apparatus 302 using a bar code scanning application. In one configuration, the code may be received from the reception component 304, which may derive the code from received signals/messages. In one configuration, the common storage component 306 may perform operations described above with reference to 202 or 204 in FIG. 2.

The apparatus may include additional components that perform each of the blocks of the algorithm in the aforementioned flowcharts of FIG. 2. As such, each block in the aforementioned flowcharts of FIG. 2 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

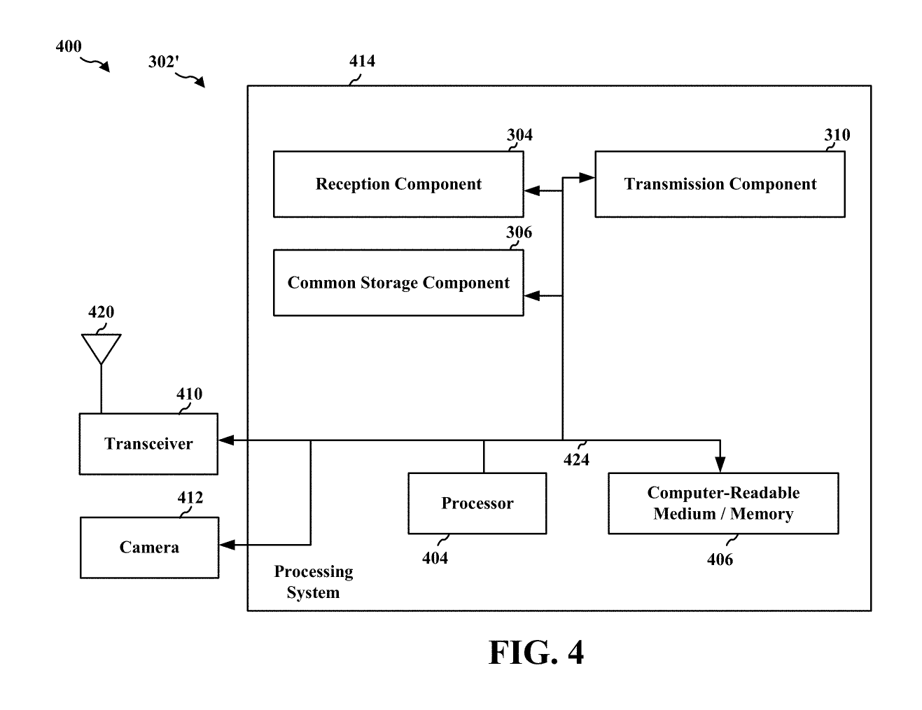

FIG. 4 is a diagram 400 illustrating an example of a hardware implementation for an apparatus 302′ employing a processing system 414. The processing system 414 may be implemented with a bus architecture, represented generally by the bus 424. The bus 424 may include any number of interconnecting buses and bridges depending on the specific application of the processing system 414 and the overall design constraints. The bus 424 links together various circuits including one or more processors and/or hardware components, represented by the processor 404, the components 304, 306, 310, and the computer-readable medium/memory 406. The bus 424 may also link various other circuits such as timing sources, peripherals, voltage regulators, and power management circuits, which are well known in the art, and therefore, will not be described any further.

The processing system 414 may be coupled to a transceiver 410. The transceiver 410 may be coupled to one or more antennas 420. The transceiver 410 provides a means for communicating with various other apparatus over a transmission medium. The transceiver 410 may receive a signal from the one or more antennas 420, extracts information from the received signal, and provides the extracted information to the processing system 414, specifically the reception component 304. In addition, the transceiver 410 may receive information from the processing system 414, specifically the transmission component 310, and based on the received information, generates a signal to be applied to the one or more antennas 420.

The processing system 414 may be coupled to a camera 412. The camera 412 may provide a means for capturing photos and/or videos, which may be stored by the processing system 414.

The processing system 414 includes a processor 404 coupled to a computer-readable medium/memory 406. The processor 404 may be responsible for general processing, including the execution of software stored on the computer-readable medium/memory 406. The software, when executed by the processor 404, may cause the processing system 414 to perform the various functions described supra for any particular apparatus. The computer-readable medium/memory 406 may also be used for storing data that is manipulated by the processor 404 when executing software. The processing system 414 further includes at least one of the components 304, 306, 310. The components may be software components running in the processor 404, resident/stored in the computer readable medium/memory 406, one or more hardware components coupled to the processor 404, or some combination thereof.

In one configuration, the apparatus 302/302′ may include means for receiving a code for a common storage mode. In one configuration, the means for receiving a code for a common storage mode may perform operations described above with referent to 202 in FIG. 2. In one configuration, the means for receiving a code for a common storage mode may be the reception component 304, the common storage component 306, the transceiver 410, the one or more antennas 420, the camera 412, or the processor 404.

In one configuration, the apparatus 302/302′ may include means for entering the common storage mode based on the code. In one configuration, the means for entering the common storage mode based on the code may be configured to validate the code and enter the common storage mode when the code is validated. In one configuration, the means for entering the common storage mode based on the code mode may perform operations described above with referent to 204 in FIG. 2. In one configuration, the means for entering the common storage mode based on the code may be the common storage component 306 or the processor 404.

In one configuration, the apparatus 302/302′ may include means for uploading photos or videos taken under the common storage mode to a common storage location based on the code. In one configuration, the means for uploading photos or videos taken under the common storage mode may be configured to derive the common storage location from the code and upload the photos or videos taken under the common storage mode to the derived common storage location. In one configuration, the means for uploading photos or videos taken under the common storage mode to a common storage location based on the code may perform operations described above with reference to 206 in FIG. 2. In one configuration, the means for uploading photos or videos taken under the common storage mode to a common storage location based on the code may be the common storage component 306, the transmission component, the transceiver 410, the one or more antennas 420, or the processor 404.

In one configuration, the apparatus 302/302′ may include means for receiving a second code associated with a second event. In one configuration, the means for receiving a second code associated with a second event may be the reception component 304, the common storage component 306, the transceiver 410, the one or more antennas 420, the camera 412, or the processor 404.

In one configuration, the apparatus 302/302′ may include means for switching from the first code to the second code when switching from the first event to the second event. In one configuration, the means for switching from the first code to the second code when switching from the first event to the second event may be configured to validate the second code, and select the second code if the second code is validated when switching from the first event to the second event. In one configuration, the means for switching from the first code to the second code when switching from the first event to the second event may be the common storage component 306 or the processor 404.

The aforementioned means may be one or more of the aforementioned components of the apparatus 302 and/or the processing system 414 of the apparatus 302′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of a camera, comprising:
receiving a code for a common storage mode;
entering the common storage mode based on the code; and
uploading photos or videos taken under the common storage mode to a common storage location based on the code.

2. The method of claim 1, wherein the camera has access to a calendar and the code is retrieved from the calendar.

3. The method of claim 1, wherein the code is shared by a plurality of cameras, wherein the common storage location is shared by the plurality of cameras.

4. The method of claim 3, wherein the code allows access to the common storage location.

5. The method of claim 3, wherein the common storage location comprises a plurality of folders, each folder for a particular one of the plurality of cameras.

6. The method of claim 3, wherein files stored at the common storage location are organized based on facial recognition.

7. The method of claim 3, wherein the code is associated with an event, wherein the code is generated by an organizer of the event and made available to attendees along with event invitations.

8. The method of claim 7, wherein the code is a bar code.

9. The method of claim 1, wherein the code comprises one or more of an effective time period for accessing the common storage mode, a duration of an event, a maximum resolution of a photo or a video to be uploaded, an access permission of the common storage location, a maximum number of photos or videos that can be uploaded by the camera, or a maximum size of photos or videos that can be uploaded by the camera.

10. The method of claim 1, wherein the code is a first code associated with a first event, the method further comprises:
receiving a second code associated with a second event; and
switching from the first code to the second code when switching from the first event to the second event.

11. The method of claim 1, further comprising:
providing a set of filtering options for the photos or videos taken under the common storage mode;
receiving a selection of the set of filtering options; and
filtering the photos or videos taken under the common storage mode for the uploading based on the selection of the filtering options.

12. An apparatus, the apparatus being a camera, comprising:
means for receiving a code for a common storage mode;
means for entering the common storage mode based on the code; and
means for uploading photos or videos taken under the common storage mode to a common storage location based on the code.

13. The apparatus of claim 12, wherein the camera has access to a calendar and the code is retrieved from the calendar.

14. The apparatus of claim 12, wherein the code is shared by a plurality of cameras, wherein the common storage location is shared by the plurality of cameras.

15. The apparatus of claim 14, wherein the code allows access to the common storage location.

16. The apparatus of claim 14, wherein the common storage location comprises a plurality of folders, each folder for a particular one of the plurality of cameras.

17. The apparatus of claim 14, wherein files stored at the common storage location are organized based on facial recognition.

18. The apparatus of claim 14, wherein the code is associated with an event, wherein the code is generated by an organizer of the event and made available to attendees along with event invitations.

19. The apparatus of claim 12, wherein the code comprises one or more of an effective time period for accessing the common storage mode, a duration of an event, a maximum resolution of a photo or a video to be uploaded, an access permission of the common storage location, a maximum number of photos or videos that can be uploaded by the camera, or a maximum size of photos or videos that can be uploaded by the camera.

20. The apparatus of claim 12, wherein the code is a first code associated with a first event, the apparatus further comprises:
means for receiving a second code associated with a second event; and
means for switching from the first code to the second code when switching from the first event to the second event.

21. An apparatus, the apparatus being a camera, comprising:
a memory; and
at least one processor coupled to the memory and configured to:
receive a code for a common storage mode;
enter the common storage mode based on the code; and
upload photos or videos taken under the common storage mode to a common storage location based on the code.

22. The apparatus of claim 21, wherein the camera has access to a calendar and the code is retrieved from the calendar.

23. The apparatus of claim 21, wherein the code is shared by a plurality of cameras, wherein the common storage location is shared by the plurality of cameras.

24. The apparatus of claim 23, wherein the code allows access to the common storage location.

25. The apparatus of claim 23, wherein the common storage location comprises a plurality of folders, each folder for a particular one of the plurality of cameras.

26. The apparatus of claim 23, wherein files stored at the common storage location are organized based on facial recognition.

27. The apparatus of claim 23, wherein the code is associated with an event, wherein the code is generated by an organizer of the event and made available to attendees along with event invitations.

28. The apparatus of claim 21, wherein the code comprises one or more of an effective time period for accessing the common storage mode, a duration of an event, a maximum resolution of a photo or a video to be uploaded, an access permission of the common storage location, a maximum number of photos or videos that can be uploaded by the camera, or a maximum size of photos or videos that can be uploaded by the camera.

29. The apparatus of claim 21, wherein the code is a first code associated with a first event, the at least one processor is further configured to:
receive a second code associated with a second event; and
switch from the first code to the second code when switching from the first event to the second event.

30. A computer-readable medium storing computer executable code, comprising code to:
receive a code for a common storage mode;
enter the common storage mode based on the code; and
upload photos or videos taken under the common storage mode to a common storage location based on the code.
